(19) United States
(12) Patent Application Publication
(10) Pub. No.: US 2024/0101449 A1
(43) Pub. Date: Mar. 28, 2024

(54) METHOD FOR DEEP REMOVAL OF DIVALENT AND TRIVALENT SCALING IONS FROM HEAVY OIL PRODUCED WATER

(71) Applicants: China National Petroliun Corporation, Beijing (CN); CNPC Research Institue of Safety & Environment Techknology Co., Ltd., Beijing City (CN)

(72) Inventors: Jiacai Xie, Beijing City (CN); Kun Tong, Beijing City (CN); Zhiguo Shao, Beijing City (CN); Zixian Wang, Beijing City (CN); Fan Nie, Beijing City (CN)

(21) Appl. No.: 18/533,991

(22) Filed: Dec. 8, 2023

Related U.S. Application Data
(63) Continuation-in-part of application No. PCT/CN2022/096754, filed on Jun. 2, 2022.

(30) Foreign Application Priority Data
Jun. 9, 2021 (CN) 202110642537.8

(51) Int. Cl. C02F 1/42; B01J 39/07; B01J 39/19; B01J 49/53; B01J 49/60; B01J 49/70

(52) U.S. Cl. CPC C02F 1/42; B01J 39/07; B01J 39/19; B01J 49/53; B01J 49/60; B01J 49/70; C02F 2103/365

(57) ABSTRACT

A method for deep removal of divalent and trivalent scaling ions from heavy oil produced water is described. The method comprises performing divalent and trivalent scaling ion deep removal treatment on heavy oil produced water by using a macroporous weak acid resin, to reduce divalent and trivalent scaling ions in the heavy oil produced water to 50 μg/L. The water quality of produced water treated using the method is superior to the boiler water standard, a silicon removal process in a conventional heavy oil produced water treatment process can be cancelled, and significant economic benefits are achieved.

### CROSS-REFERENCE TO RELATED APPLICATIONS

This application is a continuation-in-part of International Application No. PCT/CN2022/096754, filed on Jun. 2, 2022, which claims priority to Chinese Patent Application No. 202110642537.8, filed on Jun. 9, 2021, both of which are hereby incorporated by reference in their entireties.

### TECHNICAL FIELD

The present disclosure relates to the technical field of steam injection boilers for reuse of heavy oil produced water, in particular to a method for deep removal of divalent and trivalent scaling ions applicable in heavy oil produced water with high temperature, high salt content, high silicon content and high organic content.

### BACKGROUND OF ART

Heavy oil produced water is waste water with high temperature (60-90° C.), high salt content (TDS<7000 mg/L), high silicon content (SiO₂ 100-300 mg/L), and high organic content (COD 200-400 mg/L) produced in the steam assisted thermal recovery process for heavy oil, which is often reused in high-pressure steam injection boilers, and has the advantages of saving fresh water resources, saving boiler fuels, and avoiding environmental pollution. The conventional process flow of the heavy oil recovery and the reuse in steam injection boiler of heavy oil produced water is shown in FIG. 1.

The water quality indicators of the feed water for the steam injection boiler are first strictly limited in terms of hardness and silica. Generally, the hardness of the feed water should be less than 0.1 mg/L, and the silica should be less than 50 mg/L. These two indicators play an important role in preventing and controlling the scaling in the tubes of the steam injection boiler, but they also bring about three problems. First, the silica-removal treatment process is complicated, and at present, the process for removing silicon with a magnesium reagent is mainly used, which requires a large investment and a high operating cost. Second, it is difficult to remove hardness. At present, strong acid resins and weak acid resins are mainly used for hardness removal, but the hardness removal is not thorough due to the high temperature, high salt content, and high organic concentration of heavy oil produced water, and there is a risk of hardness leakage. The strong acid resin cannot fully restore the adsorption capacity after saturation or poisoning, and has a short service life. Third, in the case of controlling only the concentration of calcium and magnesium ions, the phenomenon of fouling will still occur in the tube of the steam injection boiler.

### SUMMARY OF THE INVENTION

In view of above problems, an object of the present disclosure is to provide a method suitable for deep removal of divalent and trivalent scaling ions in heavy oil produced water with high temperature, high salt content, high silicon content and high organic content. This method can effectively reduce the concentration of divalent and trivalent scaling ions in heavy oil produced water to less than 50 μg/L without cooling, removing salt, removing silicon, or removing organic matter. It does not need a process for removing silicon, shortens the process flow, reduces capex and opex, and ensures the safe operation of steam injection boilers.

In order to achieve the above object, the present disclosure provides a method for removal of divalent and trivalent scaling ions from heavy oil produced water, comprising carrying out a simultaneous removal treatment of the divalent and trivalent scaling ions in the heavy oil produced water with a macroporous weak-acid resin, to reduce the concentration of the divalent and trivalent scaling ions in the heavy oil produced water to 50 μg/L or less, wherein the raw material for the macroporous weak-acid resin includes a matrix material, a porogen, a reinforcing agent, an initiator and a dispersant in a mass ratio of (25-35):(32-50):(1-3):(0.8-1.2):(6-9).

It is found in the present disclosure that the water composition of heavy oil produced water is complicated, having, in addition to calcium and magnesium ions, divalent and trivalent scaling ions such as iron, aluminum, barium, and strontium, which tend to bond to silica to form silica scale, leading to a risk of scaling in the tube of steam injection boilers. In this regard, the method for removal of divalent and trivalent scaling ions in heavy oil produced water provided by the present disclosure can effectively remove all divalent and trivalent scaling ions (i.e. ions such as Ca²⁺, Mg²⁺, Fe²⁺, Fe³⁺, Al³⁺, Ba²⁺ and Sr³⁺) to 50 μg/L or less, which is a very low level, and reduce the probability of divalent and trivalent scaling ions bonding to silica to form silica scale (such as acmite NaFeSi₂o₆, andradite Ca₃Fe₂Si₃O₁₂ and tremolite Ca₂Mg₅Si₈O₂₂(OH)₂), so that no scaling will occur when the treated heavy oil produced water is reused in the steam injection boiler. In the specific implementation process, this method can increase the requirement of the steam injection boiler for the silica concentration in the heavy oil produced water from less than 50 mg/L at present to less than 300 mg/L.

In a specific embodiment of the present disclosure, the method for removal of divalent and trivalent scaling ions is suitable for the treatment of heavy oil produced water with high temperature, high salt content, high silicon content, and high organic content, and does not need to subject the heavy oil produced water to a cooling treatment, an organic matter removal treatment, an inorganic salt removal treatment or a silicon removal treatment (mainly refers to a silica removal treatment) in advance (i.e. before carrying out the removal treatment of the divalent and trivalent scaling ions with a macroporous weak-acid resin). With only the macroporous weak-acid resin, an effect of adsorbing inorganic salt and organic matter in the heavy oil produced water at high temperature (60-90° C.), and reducing the divalent and trivalent scaling ions in the heavy oil produced water to 50 μg/L or less can be realized. Since the content of divalent and trivalent scaling ions in the treated heavy oil produced water is extremely low, the equilibrium between scaling ions and silica can be effectively broken. Even in the case that the silica concentration in the effluent (i.e. the treated heavy oil produced water) reaches 300 mg/L, these divalent and trivalent ions at an extremely low content cannot bond to silica to form silica scale, so as to achieve an effect of avoiding the formation of silica scale without silicon removal treatment of the heavy oil produced water.

In a specific embodiment of the present disclosure, by adding the reinforcing agent, the porogen, the dispersant and the initiator and controlling the addition amount of the above components in the preparation of the macroporous weak-acid resin, the prepared macroporous weak-acid resin can have the following characteristics.

1. The macroporous weak-acid resin has both a large exchange capacity of 3.9-4.1 mmol/mL, a large pore size of 800 nm to 900 nm, and a large channel area of 800-1200 m²/g and a high mechanical strength of 290-310 N/mm², and can effectively adsorb a large amount of divalent and trivalent scaling ions and a small amount of organic matter in the heavy oil produced water. It can not only reduce the concentration of divalent and trivalent scaling ions in the heavy oil produced water to 50 μg/L or less, but also allow the organic molecules to pass through the channels of the macroporous weak-acid resin and facilitate the adsorption and desorption of organic matter, thereby effectively preventing organic fouling, saving the use of organic matter removal agents, and realizing an effective removal of divalent and trivalent scaling ions in the heavy oil produced water without removing salt or removing organic matter in advance.

2. The macroporous weak-acid resin has a low production cost and can be regenerated after saturation or poisoning. Specifically, the macroporous weak-acid resin can be regenerated by desorbing the divalent and trivalent scaling ions and macromolecular organic matter adsorbed in the resin through a regeneration method (for example, acid regeneration and alkali transformation in sequence), thereby maintaining the exchange capacity of the macroporous weak-acid resin and restoring its activity, and having regenerable and recyclable characteristics.

3. The macroporous weak-acid resin can withstand a high temperature of 95° C. or above (for example, 95-120° C.), and can keep the structure intact and unbroken under high temperature conditions. There is no need to cool down heavy oil produced water before the treatment of divalent and trivalent scaling ions, and the service life is long.

According to a specific embodiment of the present disclosure, in the macroporous weak-acid resin, the porogen can form a large number of capillary channels inside the macroporous weak-acid resin, divide the polymer formed by the matrix material into a heterogeneous gel structure and further form gel pores and capillary pores (generally having a pore volume of about 0.5 ml/g, and a pore size of 20-100 nm) inside the resin, enlarging the pore size of the macroporous weak-acid resin, increasing the channel area, accelerating the ion exchange reaction rate, and increasing the exchange capacity. This can not only improve the adsorption capacity of the macroporous weak-acid resin for divalent and trivalent scaling ions, but also the large pore size structure can allow the organic molecules of large diameter to pass through. During the adsorption, the adsorption capacity of the macroporous weak-acid resin for divalent and trivalent scaling ions is much greater than that for organic matter, so the adsorption process for inorganic ions will not be disturbed by the adsorption process for organic matter. In addition, the macroporous weak-acid resin exhibits a certain shrinkage and expansion in an acidic solution and an alkaline solution respectively, and can provide conditions for the adsorption and desorption of inorganic ions (especially divalent and trivalent scaling ions) and organic molecules in the macroporous weak-acid resin and improve the anti-pollution ability of the macroporous weak-acid resin. In some specific embodiments, the porogen may be one or a combination of two or more of toluene, xylene, polyethylene glycol and hydroxypropyl cellulose.

According to a specific embodiment of the present disclosure, in the macroporous weak-acid resin, the reinforcing agent can increase the crosslinking degree of the macroporous weak-acid resin, thereby greatly improving the mechanical strength and high temperature resistance of the macroporous weak-acid resin. In some embodiments, the macroporous weak-acid resin may have a mechanical strength of up to 290-310 N/mm², and can withstand a high temperature of 95° C. or higher (in some specific embodiments, the high temperature resistance can be 95-120° C.), which is much superior to conventional resins such as commercially available weak-acid resins. In some specific embodiments, the reinforcing agent may include acrylonitrile and/or isobutyronitrile.

It is found in the present disclosure through research that an excessively small pore size of the macroporous weak-acid resin cause its exchange capacity to be too low, resulting inan insignificant removal effect of divalent and trivalent scaling ions; and an excessively large pore size of the macroporous weak-acid resin will destroy its mechanical properties, and make the resin brittle. By controlling the amount of the porogen and the reinforcing agent within an appropriate range, the present disclosure can have high mechanical properties and improve its temperature resistance, while expanding the pore size of the macroporous weak-acid resin and obtaining a large exchange capacity and anti-fouling ability. The mass ratio of the porogen to the reinforcing agent is generally controlled to (32-50):(1-3), for example 40:2. In some specific embodiments, the addition amount of the porogen and the reinforcing agent in the raw material for the macroporous weak-acid resin can be controlled so that the mass ratio of the base material, the porogen and the reinforcing agent is 30:(40-50):(1-2).

According to a specific embodiment of the present disclosure, in the macroporous weak-acid resin, the matrix material may include an acrylate-based compound. The acrylate-based compound may include one or a combination of two or more of methyl acrylate, ethyl acrylate, methyl 2-methacrylate and ethyl 2-methacrylate.

According to a specific embodiment of the present disclosure, in the macroporous weak-acid resin, the initiator may include AIBN (azobisisobutyronitrile) and/or BPO (dibenzoyl peroxide).

According to a specific embodiment of the present disclosure, in the macroporous weak-acid resin, the dispersant may include one or a combination of two or more of polyvinyl alcohol, gelatin, and carboxymethyl cellulose.

In a specific embodiment of the present disclosure, the raw material for the macroporous weak-acid resin may further include a crosslinking agent.

According to a specific embodiment of the present disclosure, in the macroporous weak-acid resin, the crosslinking agent may include divinylbenzene and the like.

In a specific embodiment of the present disclosure, the mass ratio of the matrix material to the crosslinking agent is generally (25-35):(15-25), for example, it may be 30:20.

In some specific embodiments, the matrix material, the porogen, the reinforcing agent, the crosslinking agent, the initiator and the dispersant may be in a mass ratio of 30:(40-50):(1-2):20:1:(7-8).

In a specific embodiment of the present disclosure, the raw materials for the macroporous weak-acid resin may include by mass: 25-35 parts of the matrix material (generally an acrylate-based compound, for example, one or a combination of two or more of methyl acrylate, ethyl acrylate, methyl 2-methacrylate and ethyl 2-methacrylate), 32-50 parts of the porogen (for example, one or a combination of two or more of toluene, xylene, polyethylene glycol and hydroxypropyl cellulose), 1-3 parts of the reinforcing agent (such as acrylonitrile and/or isobutyronitrile), 15-25 parts of the crosslinking agent (such as divinylbenzene), 0.8-1.2 parts of the initiator (such as AIBN and/or BPO) and 6-9 parts of the dispersant. Preferably, the raw materials for the macroporous weak-acid resin include by mass: 30 parts of the matrix material, 32-46 parts or 30-40 parts (preferably 40 parts) of the porogen, 1-2 parts of the reinforcing agent, 20 parts of the crosslinking agent, 1 part of the initiator, and 7-8 parts of the dispersant.

According to a specific embodiment of the present disclosure, the macroporous weak-acid resin is prepared by a process generally comprising: mixing the raw material for the macroporous weak-acid resin (including the matrix material, the porogen, the reinforcing agent, the initiator, the dispersant, and optionally the crosslinking agent) and then carrying out a suspension polymerization to obtain resin beads; and subjecting the resin beads to hydrolysis to obtain the macroporous weak-acid resin.

According to a specific embodiment of the present disclosure, in the preparation method of the macroporous weak-acid resin, the suspension polymerization is carried out at a reaction temperature generally controlled at 70-95° C. (for example 85° C., or 90° C.), for a reaction time generally controlled at 7-10 hours (preferably 7-9 hours, for example 8 hours), and under a reaction pressure which is generally normal pressure.

According to a specific embodiment of the present disclosure, in the preparation method of the macroporous weak-acid resin, during the hydrolysis, the porogen can evaporate with water, thereby forming a large number of capillary channels in the resin beads, and expanding the pore size and channel area of the macroporous weak-acid resin. The hydrolysis is generally carried out at a hydrolysis temperature of 100° C. for a hydrolysis time of 1 hour.

In a specific embodiment of the present disclosure, the macroporous weak-acid resin may be prepared by a method including: mixing the matrix material, the porogen and the reinforcing agent, and then adding thereto the crosslinking agent, the initiator and the dispersant, carrying out suspension polymerization at 70-95° C. under normal pressure for 7-10 hours to obtain resin beads; then hydrolyzing the resin beads at 100° C. for 1 hour to obtain the macroporous weak-acid resin.

In a specific embodiment of the present disclosure, when the concentration of all divalent and trivalent scaling ions in the heavy oil produced water after the removal of divalent and trivalent scaling ions is greater than 50 μg/L (indicating that the macroporous weak-acid resin for removing divalent and trivalent scaling ions is saturated or poisoned), the method for removal of divalent and trivalent scaling ions in the heavy oil produced water may further include subjecting the macroporous weak-acid resin to a regeneration treatment, specifically a regeneration process of acid regeneration and alkali transformation, generally including: soaking the macroporous weak-acid resin in an acidic solution and an alkaline solution in sequence until the concentration of divalent and trivalent scaling ions reaches 50 μg/L or less after the heavy oil produced water is treated with the regenerated macroporous weak-acid resin. Specifically, the regeneration treatment may include first soaking the macroporous weak-acid resin sufficiently in an acidic solution, and removing the acidic solution; subsequently soaking the macroporous weak-acid resin sufficiently in an alkaline solution, removing the alkaline solution, washing the macroporous weak-acid resin with the untreated heavy oil produced water. The regeneration of the resin is completed when the concentration of the divalent and trivalent scaling ions in the produced water discharged from the washing is 50 μg/L or less. When the concentration of the divalent and trivalent scaling ions in the produced water discharged from the washing is greater than 50 μg/L, repeating the regeneration treatment until the concentration of the divalent and trivalent scaling ions in the produced water discharged from the washing is 50 μg/L or less.

At present, a strong-acid resin is generally used as a treatment agent in the treatment of heavy oil produced water. Since the strong-acid resin can only be regenerated with a salt solution and the volume change of the strong-acid resin is insignificant during the regeneration, the inorganic and organic impurities adsorbed by the strong-acid resin cannot be completely desorbed by the regeneration treatment, and the strong-acid resin cannot fully restore its original exchange capacity. However, the macroporous weak-acid resin used in the present disclosure can realize an alternate shrinkage and expansion of the resin volume through a process of acid regeneration and alkali transformation. Through acid and alkali elution and an alternate shrinkage and expansion of the resin, the inorganic and organic impurities in the resin can be completely desorbed, thereby fully restoring the exchange capacity. Specifically, in the above regeneration method, soaking the macroporous weak-acid resin in the acidic solution can simultaneously replace the divalent and trivalent scaling ions adsorbed in the macroporous weak-acid resin. At this time, the macroporous weak-acid resin is converted from Na⁺ type to H⁺ type, and the effluent is acidic, with a pH of less than 2. Soaking the macroporous weak-acid resin in the alkaline solution can convert the macroporous weak-acid resin from H⁺ type to Na⁺ type again, and the effluent is alkaline, with a pH of greater than 7, avoiding the influence of water quality of the produced water treated by the macroporous weak-acid resin. Meanwhile, soaking the resin layer in the acidic solution can allow the macroporous weak-acid resin to shrink, and soaking the resin layer in the alkaline solution can allow the macroporous weak-acid resin to expand. The process of shrinkage and expansion can allow the organic matter adsorbed by the macroporous weak-acid resin to detach, so as to maintain the exchange capacity of the resin and prolong the service life of the resin.

In the above regeneration method, the soaking time of the macroporous weak-acid resin in the acidic solution and the alkaline solution is generally determined according to the shrinkage and expansion of the resin. Specifically, the macroporous weak-acid resin is generally soaked in the acidic solution until the resin height is reduced by 30%. For example, the macroporous weak-acid resin is generally soaked in the acidic solution for 1 hour or more. It is soaked in the alkaline solution until the resin height is increased by 65%. For example, the macroporous weak-acid resin is generally soaked in the alkaline solution for 1.5 hours or more.

In the above regeneration method, the pH of the acidic solution is generally 2 or less, and the pH of the alkaline solution is generally 13 or more. For example, the acidic solution may be hydrochloric acid with a mass concentration of 3% to 5%. The alkaline solution may be sodium hydroxide solution with a mass concentration of 3% to 5% or the like.

In the above regeneration method, the injection flow rate of the heavy oil produced water is generally greater than 100 m³/h, when the macroporous weak-acid resin is washed with the heavy oil produced water in the regeneration treatment.

In a specific embodiment of the present disclosure, the regeneration treatment may further include washing the macroporous weak-acid resin with softened water (the concentration of divalent and trivalent scaling ions is 50 μg/L or less), which can remove impurities such as suspended matter retained in the removal process of divalent and trivalent scaling ions, before soaking the macroporous weak-acid resin in an acidic solution and/or after soaking the macroporous weak-acid resin in an alkaline solution.

The beneficial effects of the present disclosure are as follows.

The method for removing divalent and trivalent scaling ions in heavy oil produced water provided by the present disclosure uses the macroporous weak-acid resin as a softening material, and can reduce the divalent and trivalent scaling ions (that is inorganic salt content) in the heavy oil produced water with high temperature, high salt content, high silicon content and high organic content to 50 μg/L or less, without cooling down and removing organic and inorganic substances (including silica, inorganic ions and the like) in advance in the process of removing divalent and trivalent scaling ions. The treated heavy oil produced water can meet the boiler feed water quality standard on the one hand, and effectively prevent the divalent and trivalent scaling ions from bonding to silicon ions to form silica scale and prevent boiler scaling on the other hand. The method provided by the present disclosure solves the bottleneck technical problem of deep removal (i.e., reducing the ion concentration to 50 μg/L or less) of divalent and trivalent scaling ions in the heavy oil produced water with high temperature, high salt content, high silicon content and high organic content, and realizes the reuse of heavy oil produced water with high temperature, high salt content, high silicon content and high organic content in steam injection boilers, which can save a lot of energy consumption and economic cost, and has significant economic, social, and environmental benefits.

### BRIEF DESCRIPTION OF DRAWINGS

FIG. 1 is a schematic diagram of process flow of the conventional heavy oil recovery and reuse of heavy oil produced water in a steam injection boiler.

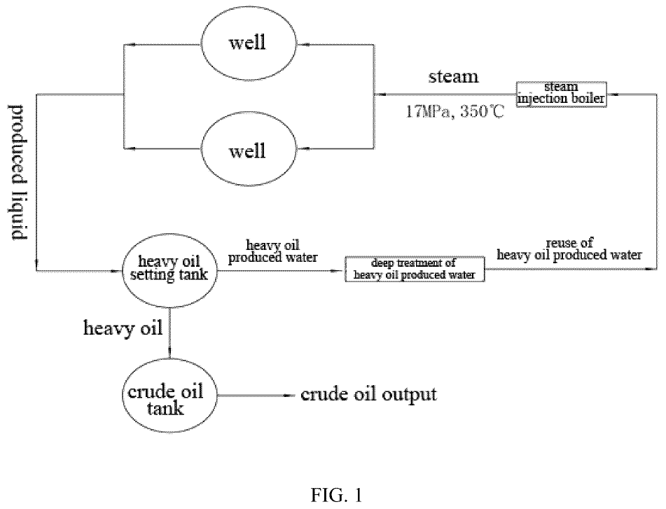

FIG. 2 shows the photos of a strong-acid resin and the macroporous weak-acid resin before and after use.

### DETAILED DESCRIPTION OF EMBODIMENTS

In order to have a clearer understanding of the technical features, purposes and beneficial effects of the present disclosure, the technical solutions of the present disclosure will now be described below in details, but it should not be construed as limiting the implementable scope of the present disclosure.

### Example 1

This example provides a macroporous weak-acid resin prepared by a method comprising:

First mixing 30 parts by mass of methyl acrylate and ethyl acrylate in a mass ratio of 2:1, 40 parts by mass of toluene and xylene in a mass ratio of 1:1, and 2 parts by mass of acrylonitrile and isobutyronitrile in a mass ratio of 10:1, then adding thereto 20 parts by mass of divinylbenzene, 1 part by mass of gelatin and polyvinyl alcohol in a mass ratio of 20:1, 7 parts by mass of carboxymethyl cellulose, and 0.8 parts by mass of AIBN and BPO in a mass ratio of 1:2, and mixing them to obtain the raw material for the macroporous weak-acid resin;

Subjecting the raw material for the macroporous weak-acid resin to suspension polymerization at 90° C. under normal pressure for 9 hours to obtain the resin beads; hydrolyzing the resin beads at 100° C. for 1 hour to obtain the macroporous weak-acid resin.

### Example 2

This example provides a macroporous weak-acid resin prepared by a method comprising:

Mixing 30 parts by mass of methyl acrylate, 50 parts by mass of toluene, and 2 parts by mass of acrylonitrile, then adding thereto 20 parts by mass of divinylbenzene, 1 part by mass of gelatin and polyvinyl alcohol in a mass ratio of 10:1, 8 parts by mass of carboxymethyl cellulose, and 1 part by mass of AIBN and BPO in a mass ratio of 1:2, and mixing them to obtain the raw material for the macroporous weak-acid resin;

Subjecting the raw material for the macroporous weak-acid resin to suspension polymerization at 85° C. under normal pressure for 8 hours to obtain the resin beads; hydrolyzing the resin beads at 100° C. for 1 hour to obtain the macroporous weak-acid resin.

### Example 3

This example provides a macroporous weak-acid resin prepared by a method which is substantially the same as the preparation method of the macroporous weak-acid resin in Example 1, only except that the total parts by mass of toluene and xylene as the porogen is increased to 50 parts in this example, while other raw material components and amounts thereof remain unchanged.

### Example 4

This example provides a macroporous weak-acid resin prepared by a method which is substantially the same as the preparation method of the macroporous weak-acid resin in Example 1, only except that the parts by mass of acrylonitrile and isobutyronitrile as the reinforcing agent is reduced to 1 part in this example, while other raw material components and amounts thereof remain unchanged.

### Example 5

This example provides a macroporous weak-acid resin prepared by a method which is substantially the same as the preparation method of the macroporous weak-acid resin in Example 1, only except that the suspension polymerization reaction is carried out at a temperature of 75° C. for 10 hours in this example, while the composition of the raw material remains unchanged.

### Comparative Example 1

This comparative example provides a macroporous weak-acid resin prepared by a method comprising:

Mixing 20 parts by mass of methyl acrylate and ethyl acrylate in a mass ratio of 1:1, 30 parts by mass of toluene and xylene in a mass ratio of 1:1, and 2 parts by mass of acrylonitrile and isobutyronitrile in a mass ratio of 5:1, then adding thereto 40 parts by mass of divinylbenzene, 5 parts by mass of gelatin and polyvinyl alcohol in a mass ratio of 5:1, and 1 part by mass of carboxymethyl cellulose, and 1.2 parts by mass of AIBN and BPO in a mass ratio of 1:2, and mixing them to obtain the raw material for the macroporous weak-acid resin;

Subjecting the raw material for the macroporous weak-acid resin to suspension polymerization at 90° C. under normal pressure for 9 hours to obtain the resin beads; hydrolyzing the resin beads at 100° C. for 1 hour to obtain the macroporous weak-acid resin.

### Test Example 1

The macroporous weak-acid resins in Examples 1 to 5 and Comparative Example 1 and commercially available conventional macroporous weak-acid resin (manufacturer: Rohm & Haas, model: D113) were tested for performance. The test methods for exchange capacity, pore size, channel area, high temperature resistance and mechanical strength were carried out in accordance with Chinese standards GB8144-1987 “Determination for exchange capacity of cation exchange resins”, GB/T 21650.2-2008 “Pore size distribution and porosity of solid materials by mercury porosimetry and gas adsorption”, and “Determination for heat resistance of strongly basic anion exchange resins used in water treatment DL/T771-2001 Appendix C”. The test results are summarized in Table 1.

TABLE 1

| | Exchange | | | High | |
|---|---|---|---|---|---|
| | capacity | Pore | Channel | temperature | Mechanical |
| | (mmol/ | size | area | resistance | strength |
| Resin No. | mL) | (nm) | (m²/g) | (° C.) | (N/mm²) |
| Example 1 | 4.1 | 800-900 | 1200 | 120 | 300 |
| Example 2 | 3.9 | 900-1000 | 1300 | 115 | 290 |
| Example 3 | 3.9 | 900-1000 | 1300 | 115 | 290 |
| Example 4 | 4.0 | 800-900 | 1200 | 118 | 310 |
| Example 5 | 4.1 | 800-900 | 1200 | 120 | 300 |
| Conventional | 2.3 | 400-600 | 800 | 80 | 120 |
| macroporous | | | | | |
| weak-acid | | | | | |
| resin | | | | | |
| Comparative | 2.1 | 200-300 | 600 | 80 | 96 |
| Example 1 | | | | | |

It can be seen from Table 1 that all the exchange capacity, pore size, channel area, high temperature resistance and mechanical strength of the macroporous weak-acid resin provided by the present disclosure are higher than those of the conventional macroporous weak-acid resin and the resin of Comparative Example 1. Specifically:

(1) The data of exchange capacity, pore size, and channel area indicate that the macroporous weak-acid resin provided by the present disclosure has higher inorganic ion adsorption capacity, especially the ability to remove divalent and trivalent scaling ions.

(2) The high temperature resistance and mechanical strength indicate that the macroporous weak-acid resin of the present disclosure is suitable for the removal process of divalent and trivalent scaling ions at high temperature, it has a structure that is not easy to break, and a longer service life.

(3) In addition, it is also detected that the macroporous weak-acid resins of Examples 1 to 5 can reduce the organic matter in the heavy oil produced water from an average COD of 350 mg/L to an average COD of 300 mg/L, indicating that the macroporous weak-acid resins provided by the present disclosure has a certain adsorption capacity for organic impurities.

In contrast, the commercially available conventional macroporous weak-acid resin and the macroporous weak-acid resin of Comparative Example 1 cannot withstand the heavy oil produced water with a maximum temperature of 90° C., and cannot carry out the process of removing divalent and trivalent scaling ions without cooling down. The exchange capacity of commercially available conventional macroporous weak-acid resin is only about 60% of the macroporous weak-acid resin of the present disclosure, the pore size and channel area thereof is about 50% of the macroporous weak-acid resin of the present disclosure, the mechanical strength thereof is 40% of the macroporous weak-acid resin of the present disclosure, and the adsorption capacity of inorganic and organic impurities and the service life are much lower than those of the macroporous weak-acid resin of the present disclosure.

### Test Example 2

This test example provides a test for the hardness removal treatment of heavy oil produced water carried out on the macroporous weak-acid resins of Examples 1 to 5 and Comparative Example 1, and conventional macroporous weak-acid resin. The hardness removal test is to determine the concentration of divalent ions and trivalent ions in the original heavy oil produced water using inductively coupled plasma (ICP) emission spectrometry. Then, 500 ml of the heavy oil produced water is treated with 500 g of the macroporous weak-acid resin to be tested, the effluent is collected after 5 min, and the concentration of divalent ions and trivalent ions in the effluent are determined using the above method. The results are shown in Table 2.

TABLE 2

| | Ca²⁺ | Mg²⁺ | Fe²⁺ | Fe³⁺ | Al³⁺ | Ba²⁺ | Sr³⁺ | Total |
|---|---|---|---|---|---|---|---|---|
| Item | Concentration unit: μg/L | | | | | | | |
| Original heavy | 19880 | 5214 | 72 | 31 | 350 | 241 | 520 | 26308 |
| oil produced | | | | | | | | |
| water | | | | | | | | |
| Example 1 | 3.1 | 4.2 | 5.1 | 2.2 | 1.9 | 4.1 | 2.9 | 23.5 |
| Example 2 | 21.9 | 1.1 | 4.1 | 5.1 | 2.2 | 3.1 | 4.8 | 42.3 |
| Example 3 | 18.5 | 3.2 | 3.9 | 4.3 | 3.3 | 2.7 | 4.5 | 40.4 |
| Example 4 | 10.7 | 2.5 | 2.3 | 3.2 | 1.9 | 5.9 | 8.2 | 34.7 |
| Example 5 | 24.6 | 5.3 | 3.5 | 2.3 | 2.9 | 3.8 | 7.2 | 49.6 |
| Comparative | 346.2 | 63.1 | 2.8 | 3.2 | 12.7 | 82 | 67 | 577 |
| Example 1 | | | | | | | | |
| Conventional | 263.9 | 16.3 | 10.1 | 12.5 | 18.9 | 52.8 | 87.5 | 462 |
| macroporous | | | | | | | | |
| weak-acid resin | | | | | | | | |

It can be seen from Table 2 that the macroporous weak-acid resin provided by the present disclosure has a removal efficiency of divalent and trivalent scaling ions such as Ca²⁺ Mg²⁺, Fe²⁺, Fe³⁺, Al³⁺, Ba²⁺ and Sr³⁺ in the heavy oil produced water, significantly higher than that of conventional macroporous weak-acid resin and Comparative Example 1. The concentration of divalent and trivalent scaling ions such as Ca²⁺, Mg²⁺, Fe²⁺, Fe³⁺, Al³⁺, Ba²⁺ and Sr³⁺ in the heavy oil produced water treated with the macroporous weak-acid resin provided by the present disclosure is reduced from 26308 μg/L to 50 μg/L or less, while Comparative Example 1 and the conventional macroporous weak-acid resin could reduce the concentration of divalent and trivalent scaling ions such as Ca²⁺, Mg²⁺, Fe²⁺, Fe³⁺, Al³⁺, Ba²⁺ and Sr³⁺ in the heavy oil produced water from 26308 μg/L to 577 μg/L and 462 μg/L, which are much higher than 50 μg/L.

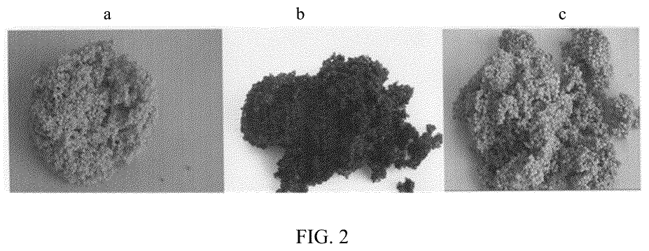

The macroporous weak-acid resin prepared in Example 1 and the conventional strong-acid resin (manufacturer: Rohm & Haas, resin model: 001×7) are respectively applied to the treatment process of heavy oil produced water. FIG. 2a is a photo of the unused strong-acid resin, and the state of the unused macroporous weak-acid resin is also similar to that in FIG. 2a. FIG. 2b is a photo of the used strong-acid resin, and it can be seen that the surface of the strong-acid resin shows an obvious discoloration after the hardness removal treatment of heavy oil produced water. FIG. 2c is a photo of the used macroporous weak-acid resin, and it can be seen that the surface of the macroporous weak-acid resin has no obvious discoloration after the hardness removal treatment of heavy oil produced water.

When the concentration of divalent and trivalent scaling ions in the effluent treated with the macroporous weak-acid resin prepared by the present disclosure is greater than 50 g/L, it indicates that the resin is poisoned, and the resin can be regenerated by a process of acid regeneration and alkali transformation, specifically as follows:

Rinsing the poisoned macroporous weak-acid resin with demineralized water, soaking the resin in 3-5% dilute hydrochloric acid, and removing the acidic solution when it is observed that the resin height is decreases by 30% (usually 1 hour or more), then soaking the resin in 3-5% sodium hydroxide solution, and removing the alkaline solution when it is observed that the resin height is increased by 65% (generally 1.5 hours or more), rinsing off the excess alkaline solution with demineralized water, and completing the regeneration.

When the hardness of the effluent treated with conventional strong-acid resin is greater than 0.5 mg/L, it indicates that the strong-acid resin has been poisoned. The resin is soaked in the above acidic solution and alkaline solution for the same time respectively, and the excess alkaline solution is rinse off with demineralized water.

During the alkali transformation of the regeneration treatment, the expansion rates of the strong-acid resin and the macroporous weak-acid resin after soaking in the alkaline solution for the same time are measured to be 5% and 65%, respectively.

It can be seen from the above results that the conventional strong-acid resin has a strong binding ability with the impurities, especially the organic matter and suspended matter in the heavy oil produced water. The expansion rate of the strong-acid resin in the alkaline solution is limited, and it is difficult for the adsorbed impurities to desorb, so the strong-acid resin cannot restore the adsorption capacity through the treatment of acid regeneration and alkali transformation. In contrast, the macroporous weak-acid resin provided by the present disclosure has better expandability and weaker binding ability with adsorbed organic matter and suspended matter, so it can completely remove calcium ions, magnesium ions, organic matter and the like adsorbed in the macroporous weak-acid resin, and completely restore the exchange capacity and adsorption activity of the poisoned macroporous weak-acid resin by the volume change of shrinkage and expansion during acid regeneration and alkali transformation process, so as to achieve an effect of recycling and saving costs.

In summary, as compared with the conventional macroporous weak-acid resins and strong-acid resins, the macroporous weak-acid resin provided by the present disclosure is more suitable for effective removal of divalent and trivalent scaling ions in the heavy oil produced water without cooling down, removing salts, removing silicon and removing organic matter, to ensure that the steam injection boiler does not scale; even poisoned or saturated, it can restore the exchange capacity through the regeneration process and has a long service life.

What is claimed:

1. A method for deep removal of divalent and trivalent scaling ions from heavy oil produced water, comprising carrying out a deep removal treatment of the divalent and trivalent scaling ions in the heavy oil produced water with a macroporous weak-acid resin, to reduce the concentration of the divalent and trivalent scaling ions in the heavy oil produced water to 50 μg/L or less, wherein the raw material for the macroporous weak-acid resin includes a matrix material, a porogen, a reinforcing agent, an initiator and a dispersant in a mass ratio of (25-35):(32-50):(1-3):(0.8-1.2):(6-9).

2. The method for deep removal of divalent and trivalent scaling ions from heavy oil produced water according to claim 1, wherein the method does not include one or a combination of two or more of a cooling treatment, an organic matter removal treatment, an inorganic salt removal treatment and a silicon removal treatment of the heavy oil produced water in advance.

3. The method for deep removal of divalent and trivalent scaling ions from heavy oil produced water according to claim 1, wherein the macroporous weak-acid resin has:
an exchange capacity of 3.9 mmol/mL to 4.1 mmol/mL;
a pore size of 800 nm to 900 nm;
a mechanical strength of 290 N/mm² to 310 N/mm²;
a channel area of 800 m²/g to 1200 m²/g; and
resistance to a temperature of 95° C. or more.

4. The method for deep removal of divalent and trivalent scaling ions from heavy oil produced water according to claim 3, wherein the macroporous weak-acid resin has resistance to a temperature of 95° C. to 120° C.

5. The method for deep removal of divalent and trivalent scaling ions from heavy oil produced water according to claim 1, wherein the mass ratio of the porogen to the reinforcing agent is 40:2.

6. The method for deep removal of divalent and trivalent scaling ions from heavy oil produced water according to claim 5, wherein the matrix material, the porogen, the reinforcing agent, the initiator and the dispersant are in a mass ratio of 30:(40-50):(1-2):1:(7-8).

7. The method for deep removal of divalent and trivalent scaling ions from heavy oil produced water according to claim 1, wherein
the reinforcing agent includes acrylonitrile and/or isobutyronitrile;
the porogen includes one or a combination of two or more of toluene, xylene, polyethylene glycol and hydroxypropyl cellulose;
the matrix material includes an acrylate-based compound; and
the dispersant includes one or a combination of two or more of polyvinyl alcohol, gelatin, and carboxymethyl cellulose.

8. The method for deep removal of divalent and trivalent scaling ions from heavy oil produced water according to claim 7, wherein the acrylate-based compound includes one or a combination of two or more of methyl acrylate, ethyl acrylate, methyl 2-methacrylate and ethyl 2-methacrylate.

9. The method for deep removal of divalent and trivalent scaling ions from heavy oil produced water according to claim 1, wherein the raw material for the macroporous weak-acid resin further comprises a crosslinking agent including divinylbenzene.

10. The method for deep removal of divalent and trivalent scaling ions from heavy oil produced water according to claim 9, wherein the mass ratio of the matrix material to the crosslinking agent is (25-35):(15-25).

11. The method for deep removal of divalent and trivalent scaling ions from heavy oil produced water according to claim 9, wherein the mass ratio of the matrix material to the crosslinking agent is 30:20.

12. The method for deep removal of divalent and trivalent scaling ions from heavy oil produced water according to claim 1, wherein the macroporous weak-acid resin is prepared by a process comprising:
mixing the raw material for the macroporous weak-acid resin and then carrying out suspension polymerization to obtain resin beads; and
subjecting the resin beads to hydrolysis to obtain the macroporous weak-acid resin.

13. The method for deep removal of divalent and trivalent scaling ions from heavy oil produced water according to claim 12, wherein the suspension polymerization is carried out at a reaction temperature of 70-95° C. for a reaction time of 7 hours to 10 hours under normal pressure; and the hydrolysis is carried out at a hydrolysis temperature of 100° C. for a hydrolysis time of 1 hour.

14. The method for deep removal of divalent and trivalent scaling ions from heavy oil produced water according to claim 1, wherein the method further includes carrying out a regeneration treatment of the macroporous weak-acid resin, when the concentration of divalent and trivalent scaling ions in the heavy oil produced water is greater than 50 g/L after the removal of the divalent and trivalent scaling ions.

15. The method for deep removal of divalent and trivalent scaling ions from heavy oil produced water according to claim 14, wherein the regeneration treatment includes soaking the macroporous weak-acid resin in an acidic solution and in an alkaline solution successively, until the concentration of divalent and trivalent scaling ions reaches 50 μg/L or less after the heavy oil produced water is treated by the regenerated macroporous weak-acid resin.

16. The method for deep removal of divalent and trivalent scaling ions from heavy oil produced water according to claim 14, wherein the regeneration treatment includes:
first soaking the macroporous weak-acid resin sufficiently in an acidic solution, and removing the acidic solution;
subsequently soaking the macroporous weak-acid resin sufficiently in an alkaline solution, removing the alkaline solution, and washing the macroporous weak-acid resin with the heavy oil produced water,
wherein the regeneration of the resin is completed when the concentration of divalent and trivalent scaling ions in the produced water discharged from the washing is 50 μg/L or less; or
when the concentration of divalent and trivalent scaling ions in the produced water discharged from the washing is greater than 50 μg/L, repeating the regeneration treatment until the concentration of divalent and trivalent scaling ions in the produced water discharged from the washing is 50 μg/L or less.

17. The method for deep removal of divalent and trivalent scaling ions from heavy oil produced water according to claim 14, wherein the macroporous weak-acid resin is soaked in the acidic solution for 1 hour or more, and the macroporous weak-acid resin is soaked in the alkaline solution for 1.5 hours or more.

18. The method for deep removal of divalent and trivalent scaling ions from heavy oil produced water according to claim 14, wherein the acidic solution used for soaking the macroporous weak-acid resin has a pH of ≤2, and the alkaline solution used for soaking the macroporous weak-acid resin has a pH of ≥13;
wherein the acidic solution includes a hydrochloric acid solution with a mass concentration of 3 to 5%, and the alkaline solution includes a sodium hydroxide solution with a mass concentration of 3 to 5%.

19. The method for deep removal of divalent and trivalent scaling ions from heavy oil produced water according to claim 14 wherein in the regeneration treatment, the injection flow rate of the heavy oil produced water is greater than 100 m³/h when the macroporous weak-acid resin is washed with the heavy oil produced water.

20. The method for deep removal of divalent and trivalent scaling ions from heavy oil produced water according to claim 19, wherein the regeneration treatment further includes washing the macroporous weak-acid resin with demineralized water, before soaking the macroporous weak-acid resin in an acidic solution and/or after soaking the macroporous weak-acid resin in an alkaline solution.
